(19) United States
(12) Patent Application Publication
(10) Pub. No.: US 2011/0298994 A1
(43) Pub. Date: Dec. 8, 2011

(54) AIR FILTER CLEANER AND VIDEO PROJECTOR

(75) Inventors: Yosuke Nishihata, Hirakata-shi (JP); Fumihiko Hamada, Kobe-shi (JP); Akira Miyanaga, Daito-shi (JP); Yoshiharu Arioka, Osaka-shi (JP); Hideaki Okaniwa, Nagoya-shi (JP)

(73) Assignee: SANYO ELECTRIC CO., LTD., Osaka (JP)

(21) Appl. No.: 13/153,881

(22) Filed: Jun. 6, 2011

(30) Foreign Application Priority Data
Jun. 8, 2010 (JP) 2010-131294

(51) Int. Cl. H04N 9/31; A46B 15/00

(52) U.S. Cl. 348/744; 15/160; 348/E09.025

(57) ABSTRACT

An air filter cleaner includes an air filter that captures dust. A brush cleans the air filter. A dust box collects dust from the brush. A rotary shaft rotates the brush. A moving mechanism moves the brush and the dust box using the rotation of the brush. A one-way clutch connects the brush and the rotary shaft.

### CROSS-REFERENCE TO RELATED APPLICATIONS

This application is based upon and claims the benefit of priority from prior Japanese Patent Application No. 2010-131294, filed on Jun. 8, 2010, the entire contents of which are incorporated herein by reference.

### BACKGROUND OF THE INVENTION

The present invention relates to an air filter cleaner including a brush that cleans an air filter and to a video projector including the air filter cleaner.

A typical video projector includes an air filter, which is arranged in a frame (an outer case) of the projector. The air filter captures dust from the air drawn into the frame. Japanese Laid-Open Patent Publication No. 2007-156186 describes a projector including a brush that linearly moves back and forth to clean the air filter.

Japanese Laid-Open Patent Publication No. 2009-82837 describes an air conditioner including an air filter cleaner. The air filter cleaner includes a brush, which cleans an air filter, a dust box, which collects dust from the brush, and a moving mechanism, which moves the brush and the dust box using the rotation of a rotary shaft that rotates the brush.

It is preferable that the dust on the brush, cleaned off from the air filter, be removed from the brush to prevent the cleaning capability of the brush from deteriorating. Further, it is preferable that the dust removed from the brush be collected in the dust box so that the dust does not enter the frame.

However, in the structure that moves the brush and the dust box using the rotation of the rotary shaft, which rotates the brush, as long as the rotary shaft and the brush are coupled to each other, the direction in which the brush rotates is changed in accordance with the movement direction of the brush and the dust box. For example, when the brush and the dust box move in a first direction, the brush rotates in a direction that collects dust in the dust box. When the brush and the dust box move in a second direction, which is opposite the first direction, the brush does not rotate in the direction that collects dust in the dust box. Instead, the brush rotates in a direction opposite to the direction for collecting dust in the dust box. This results in the dust on the brush being returned to the air filter rather than being collected in the dust box.

### SUMMARY OF THE INVENTION

Other aspects and advantages of the present invention will become apparent from the following description, taken in conjunction with the accompanying drawings, illustrating by way of example the principles of the invention.

One aspect of the present invention is an air filter cleaner including an air filter that captures dust. A brush cleans the air filter. A dust box collects dust from the brush. A rotary shaft rotates the brush. A moving mechanism moves the brush and the dust box using the rotation of the rotary shaft. A one-way clutch connects the brush and the rotary shaft.

### BRIEF DESCRIPTION OF THE DRAWINGS

The invention, together with objects and advantages thereof, may best be understood by reference to the following description of the presently preferred embodiments together with the accompanying drawings in which:

FIGS. 1(a) and 1(b) are perspective views showing a video projector according to one embodiment of the present invention;

FIG. 2 is a schematic diagram of an optical system in the video projector of FIG. 1(a);

FIG. 3 is a side view showing the video projector of FIG. 1(a);

FIG. 4 is a perspective view showing an air filter cleaner of FIG. 1(a);

FIG. 5 is a plan view showing the air filter cleaner of FIG. 4;

FIG. 6 is an exploded perspective view showing a cleaning unit arranged in the air filter cleaner of FIG. 4;

FIG. 7 is a schematic plan view showing a moving mechanism arranged on the air filter cleaner of FIG. 4;

FIG. 8 is a cross-sectional view of a one-way clutch taken along line B-B in FIG. 7;

FIG. 9 is a perspective view showing a dust box, in an open state, arranged in the cleaning unit of FIG. 6;

FIG. 10 is a cross-sectional view of the cleaning unit taken along line A-A in FIG. 5;

FIG. 11 is a cross-sectional view of the cleaning unit taken along line A-A in FIG. 5; and

FIGS. 12(a) and 12(b) are schematic cross-sectional views showing the direction in which a brush is rotated in the cleaning unit when the brush is connected to a rotary shaft without the one-way clutch.

### DETAILED DESCRIPTION OF THE INVENTION

A projector 1 according to one embodiment of the present invention will now be discussed with reference to the drawings.

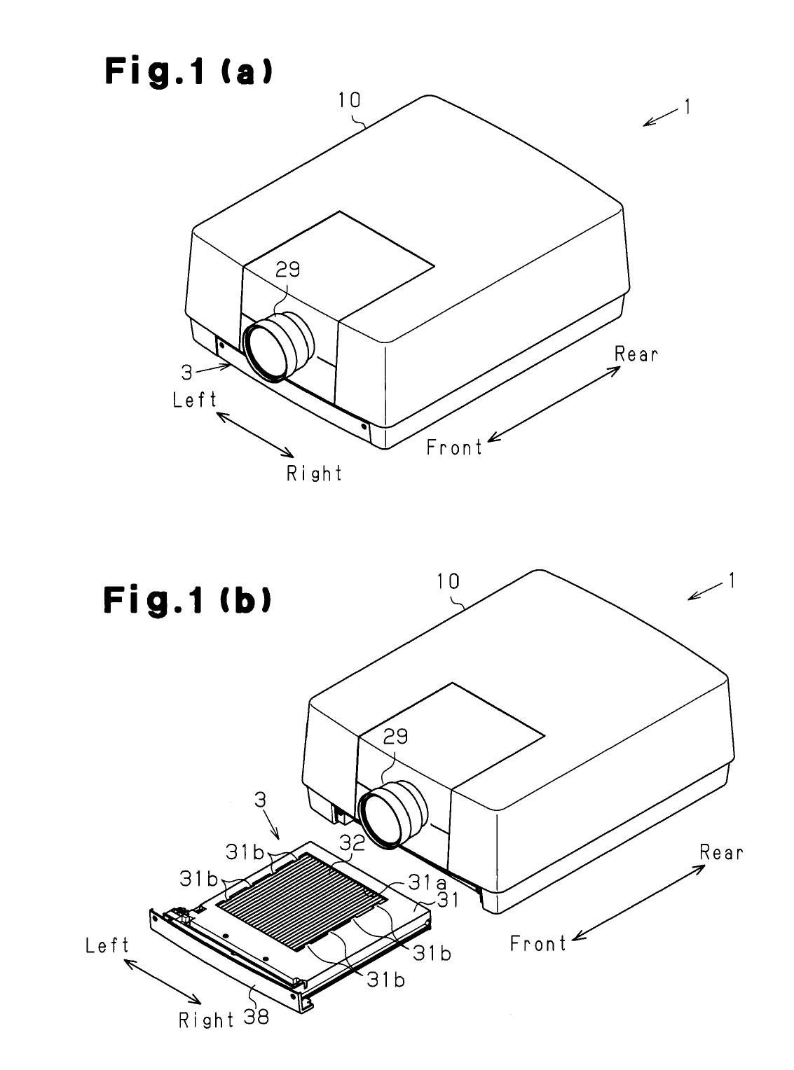

FIG. 1 shows the projector 1 arranged in a horizontal state. The projector 1 projects image light toward the front from a projection lens 29 to display an image. The projector 1 includes an outer case 10, or a frame, which accommodates electronic components and optical components. The outer case 10 includes a front surface, a rear surface, a right surface, a left surface, an upper surface, and a lower surface. In the description hereafter, unless otherwise indicated, the upper, lower, left, right, front, and rear directions are as indicated by the arrows shown in FIG. 1.

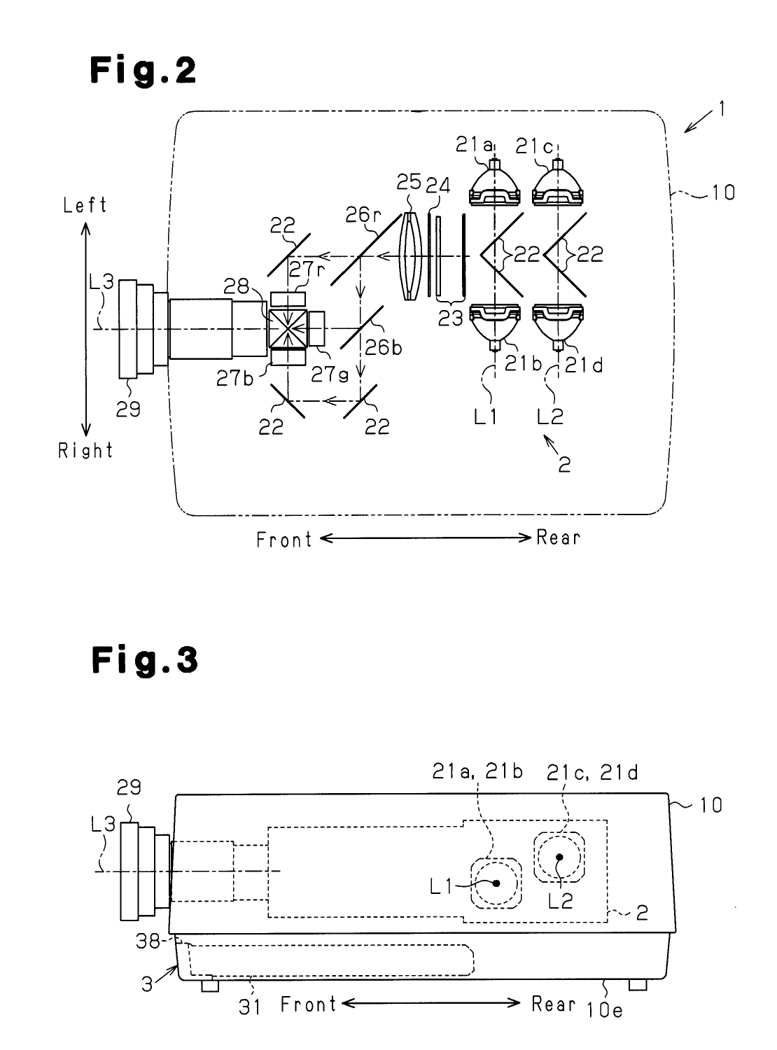

As shown in FIGS. 2 and 3, the projector 1 includes an optical system 2. The optical system 2 includes optical components, such as lamps 21a, 21b, 21c, and 21d, dichroic mirrors 26r and 26b, liquid crystal light valves 27r, 27g, and 27b, a cross-dichroic prism 28, and the projection lens 29. The lamps 21a, 21b, 21c, and 21d serve as a light source for displaying an image. The dichroic mirrors 26r and 26b separate white light into the three primary colors of light, namely, red light, green light, and blue light. The liquid crystal light valves 27r, 27g, and 27b respectively correspond to the three primary colors of light.

The lamps 21a, 21b, 21c, and 21d each emit white light as collimated light. Further, the lamps 21a, 21b, 21c, and 21d may each be formed by a discharge lamp, such as an ultrahigh pressure mercury lamp or metal halide lamp. The lamp 21a has an optical axis L1 aligned with that of the lamp 21b. The lamp 21c has an optical axis L1 aligned with that of the lamp 21d. In the illustrated example, the optical axes of the lamps 21a, 21b, 21c, and 21d are parallel to each other.

The lamps 21a, 21b, 21c, and 21d are arranged so that the height of the optical axis L1 differs from that of the optical axis L2. In the example of FIG. 3, the lamps 21a and 21b are closer to the lower surface 10e of the outer case 10 than the lamps 21c and 12d.

The light emitted from the lamps 21a, 21b, 21c, and 21d is reflected by corresponding full-reflection mirrors 22 and guided via an integrator lens 23, a polarizing beam splitter 24, and a condenser lens 25 to the liquid crystal light valves 27r, 27g, and 27b. The integrator lens 23 includes two fly's eye lens and realizes uniform illuminance distribution. The polarizing beam splitter 24 set the polarization direction in a predetermined direction. The condenser lens 25 condenses the light that enters the liquid crystal light valves 27r, 27g, and 27b.

The dichroic mirror 26r, which transmits red light, and the dichroic mirror 26b, which transmits blue light, separates the white light emitted from the lamps 21a, 21b, 21c, and 21d into red light, green light, and blue light.

The red light enters the liquid crystal light valve 27r. The green light enters the liquid crystal light valve 27g. The blue light enters the liquid crystal light valve 27b. The liquid crystal light valves 27r, 27g, and 27b are light valves that vary the transmission rate of light for each pixel. Transmission of the red light, green light, and blue light through the corresponding liquid crystal light valves 27r, 27g, and 27b generate a red image, green image, and blue image.

The cross-dichroic prism 28 combines the light of the red, green, and blue images, which are generated by the liquid crystal light valves 27r, 27g, and 27b, to generate a full-color image. The projection lens 29 projects the light of the image. In this manner, the projector 1 displays the image on a flat surface arranged in front of the projector 1, such as a screen or a wall. As shown in FIG. 2, the optical axis L3 of the projection lens 29 is orthogonal to the optical axes L1 and L2.

To prolong the life of the lamps 21a, 21b, 21c, and 21d, which generate heat when emitting light, the lamps 21a, 21b, 21c, and 21d must be arranged so that their optical axes L1 and L2 are not oriented in the vertical direction. In the present embodiment, the optical axes L1 and L2 are orthogonal to the optical axis L3. Thus, the direction of the projection lens 29 (optical axis L3) may be changed while keeping the optical axes L1 and L2 horizontal. For example, the projector 1 may be arranged so that its lower surface 10e faces toward a horizontal surface or ceiling to display an image on a screen or wall. The projector 1 may also be arranged so that its lower surface 10e faces toward a wall to display an image on the floor or ceiling.

The illustrated projector 1 is a four-lamp, three-LCD projector. In addition to the optical components described above, the outer case 10 accommodates electronic components (not shown), which drive liquid crystal panels of the liquid crystal light valves 27r, 27g, and 27b, and an intake fan, which cools the optical components and electronic components. The intake fan is driven to draw air into the outer case 10.

The projector 1 includes an air filter device 3 (refer to FIG. 1). The air filter device 3 captures dust from the air entering the outer case 10. In the description hereafter, the direction oriented into the outer case 10 will be referred to as an inward or downstream direction.

As shown in FIG. 1(a), the air filter device 3 is coupled to a lower portion of the outer case 10. The air filter device 3 is drawn out from the front of the outer case 10 for removal from the projector 1. To couple the air filter device 3 to the projector 1, the air filter device 3 is pushed rearward into the outer case 10.

The air filter device 3 includes a base 31, which is formed from a resin material. The base 31 includes a tetragonal opening 31a, which serves as an air inlet. An electrostatic filter 32 is arranged on the base 31 to cover the opening 31a. The opening 31a is further covered by a urethane filter (not shown). The urethane filter is an air filter formed from urethane.

The electrostatic filter 32 is an air filter formed from electrostatic fibers. The electrostatic filter 32 may include a corrugated filter element. The electrostatic filter 32 and urethane filter are elastically deformable. For example, the edges of the electrostatic filter 32 and urethane filter are elastically compressed and embedded in the base 31. Tabs 31b are formed integrally with the base 31 to prevent separation and displacement of the electrostatic filter 32 and urethane filter.

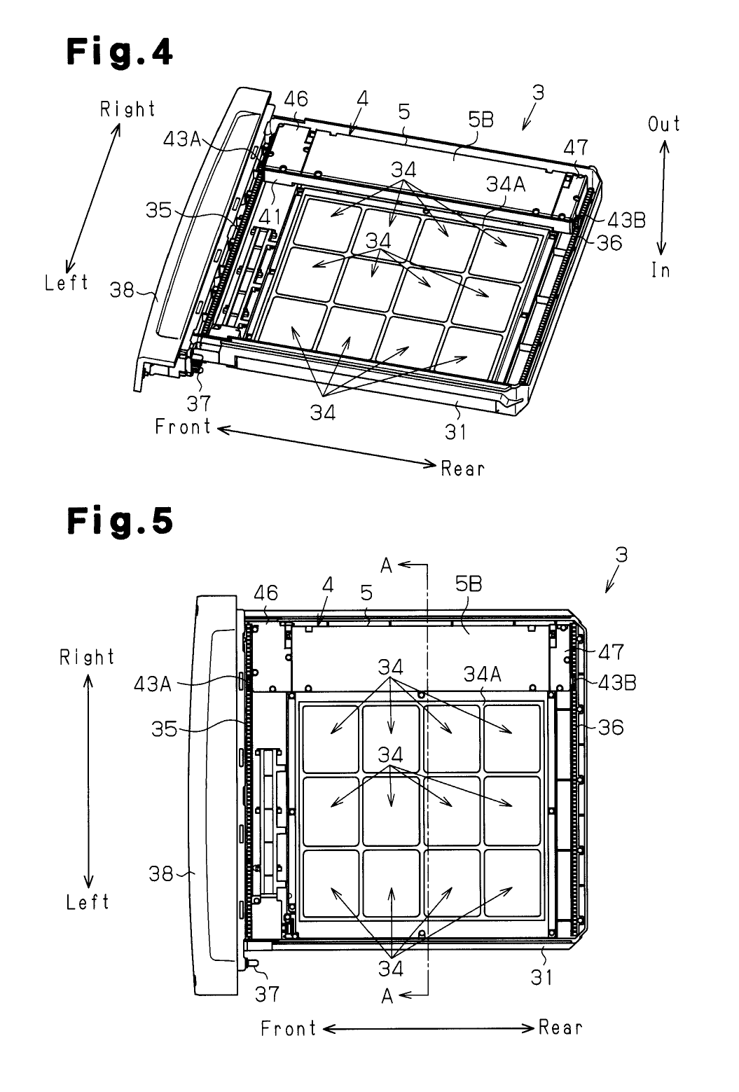

The structure at the outer side of the air filter device 3 will now be described with reference to FIGS. 4 and 5. The air filter device 3 includes an air filter 34, which is arranged outward from the electrostatic filter 32 and urethane filter. The air filter 34 is adhered or fused to a grid 34A. The grid 34A is fastened by screws to the base 31.

Linear first and second racks 35 and 36 are fastened to the base 31. The first rack 35 is fixed to the grid 34A at a location frontward from the air filter 34. The second rack 36 is fixed to the grid 34A at a location rearward from the air filter 34. The racks 35 and 36 are parallel to each other and arranged on opposite sides of the air filter 34.

A connector 37 of the air filter device 3 is arranged on a front part of the base 31. When the air filter device 3 is coupled to the projector 1, the connector 37 is connected to a connector (not shown) of the projector 1. Connection of the connector 37 with the connector of the projector 1 allows for power to be supplied from the projector 1 to the electrical components of the air filter device 3.

A panel 38 is coupled to the front of the base 31. The panel 38 is flush with the outer surface of the outer case 10 when the air filter device 3 is coupled to the projector 1.

When the air filter device 3 is coupled to the projector 1, a triple-layer air filter, which is formed by the electrostatic filter 32, the urethane filter, and the air filter 34, covers the opening 31a. The electrostatic filter 32 and the urethane filter may each be referred to as an inner filter. The air filter 34 may be referred to as an outer filter.

The air filter device 3 includes a cleaning unit 4, which automatically cleans the air filter 34. The air filter device 3 may be referred to as an air filter cleaner. The cleaning unit 4 is, for example, generally box-shaped. When the cleaning unit 4 is not cleaning the air filter 34, the cleaning unit 4 is separated from the air filter 34 and located at a non-cleaning position.

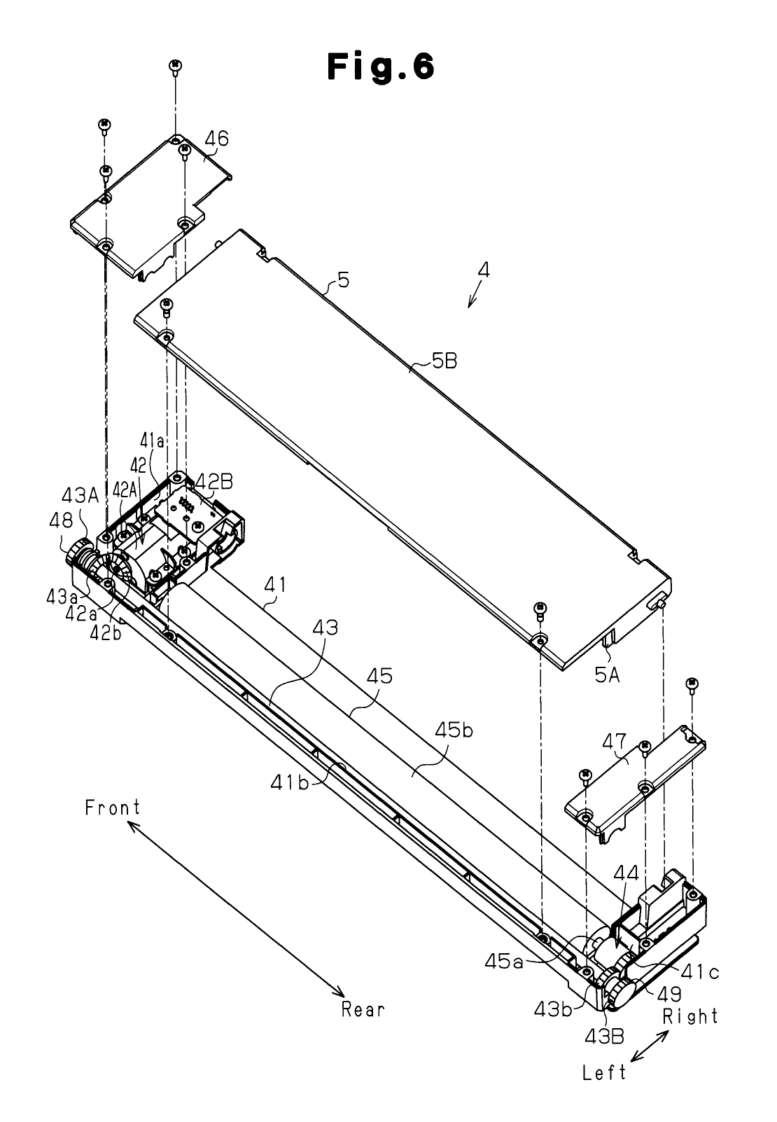

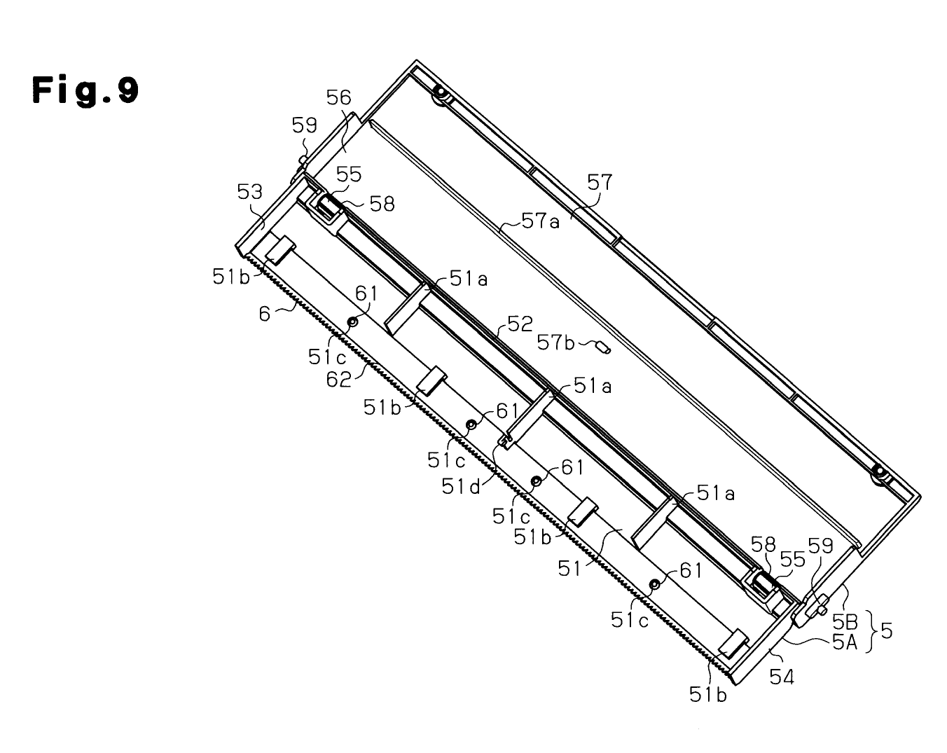

As shown in FIG. 6, the cleaning unit 4 includes a case 41, covers 46 and 47, a brush 45, a dust box 5, and a dust remover 6 (refer to FIG. 9). The covers 46 and 47 are fastened by screws to the case 41. The brush 45 cleans the air filter 34. The dust box 5 is fastened by screws to the case 41 to collect dust from the brush 45. The dust remover 6 removes dust from the brush 45.

A motor compartment 41a is arranged in the front part of the case 41. A motor 42 is accommodated in the motor compartment 41a. A rotary shaft compartment 41b is arranged in the left part of the case 41 extending from the front part to the rear part of the case 41. The rotary shaft compartment 41b accommodates a rotary shaft 43, which is rotated by the motor 42.

A power transmission mechanism compartment 41c is arranged at the rear part of the case 41. The power transmission mechanism compartment 41c accommodates a one-way clutch 44, which transmits the rotation of the rotary shaft 43 to the brush 45. The brush 45 and the dust box 5 are arranged in the right part of the case 41 surrounded by the motor compartment 41a at the front, the power transmission mechanism compartment 41c at the rear, and the rotary shaft compartment 41b at the left.

The motor 42 is the power source of the cleaning unit 4. A motor cover 42A (refer to FIG. 6) is fastened by screws to the case 41 to cover the motor 42. The motor 42 includes an output shaft 42a. A bevel gear 42b is arranged on the output shaft 42a. The motor 42 rotates the bevel gear 42b when supplied with power via the connector 37 from the projector 1. In the illustrated example, the output shaft 42a of the motor 42 extends leftward. The bevel gear 42b is arranged in the rotary shaft compartment 41b.

A printed wiring board 42B (refer to FIG. 6) is accommodated in the motor compartment 41a. Power supply wires for the motor 42 are laid out on the printed wiring board 42B. The motor 42 moves integrally with the case 41. It is thus preferable that the motor 42 be connected to the connector 37, which is arranged on the base 31, by the printed wiring board 42B and a film-like flexible cable (not shown).

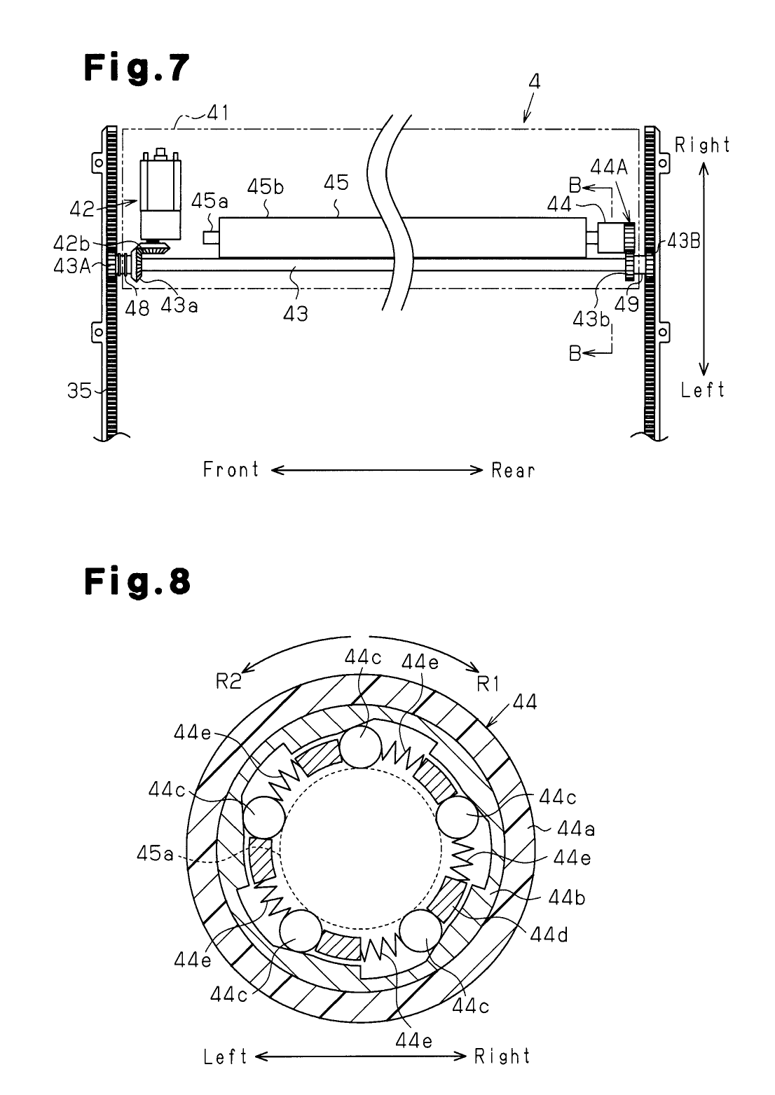

As shown in FIG. 7, a bevel gear 43a, which is engaged with the bevel gear 42b, is arranged on a front end of the rotary shaft 43. A spur gear 43b, which is connected to the one-way clutch 44, is arranged on a rear end of the rotary shaft 43. The motor 42 rotates the rotary shaft 43 with the bevel gears 42b and 43a. The spur gear 43b of the rotary shaft 43 transmits the rotation of the rotary shaft 43 to the one-way clutch 44. The rotary shaft 43 may be formed from a metal material.

A first pinion 43A is arranged on the front end of the rotary shaft 43. A second pinion 43B is arranged on the rear end of the rotary shaft 43. The pinions 43A and 43B may be formed from a resin material. The first pinion 43A projects frontward from the case 41. The second pinion 43B projects rearward from the case 41. The first and second pinions 43A and 43B are respectively engaged with the first and second racks 35 and 36. When the motor 42 generates rotation, the engagement of the racks 35 and 36 with the pinions 43A and 43B move the cleaning unit 4 leftward and rightward.

The bevel gear 43a and the first pinion 43A may be formed as a single resin member 48 that has superior sliding characteristics. The bevel gear 43b and the second pinion 43B may also be formed as a single resin member 49 that has superior sliding characteristics. An intermediate collar between the bevel gear 43a and the first pinion 43A is supported by the front end of the case 41. An intermediate collar between the bevel gear 43b and the second pinion 43B is supported by the front end of the case 41. In this manner, the case 41 supports the rotary shaft 43 in a rotatable manner. Further, the rotary shaft 43 is supported by portions other than the front and rear ends of the case 41.

The one-way clutch 44 will now be described with reference to FIG. 8. The brush 45 includes a shaft 45a, which is inserted into the one-way clutch 44.

The one-way clutch 44 includes a housing 44a, a race 44b, rollers 44c, holders 44d, and springs 44e. The race 44b, which is ring-shaped, is fixed to the housing 44a. The rollers 44c are arranged along the inner surface of the race 44b. The holders 44d hold the rollers 44c. The springs 44e urge the rollers 44c. The housing 44a and the race 44b are constantly rotated by the rotary shaft 43. The housing 44a and the race 44b may be referred to as a mechanical element connected to the rotary shaft 43.

The housing 44a is cylindrical and may be formed from a resin material having superior sliding characteristics. The race 44b may be formed from an alloy, such as carbon steel, or a metal material. The rollers 44c are cylindrical and may be formed from an alloy, such as carbon steel, or a metal material.

The distance between the inner surface of the race 44b and the outer surface of the shaft 45a, which is inserted into the one-way clutch 44, varies in accordance with the circumferential position. The springs 44e urge the rollers 44c so that the rollers 44c are clamped between the race 44b and the shaft 45a and function as locks. To reduce the number of components, it is preferable that the springs 44e be formed integrally with the holders 44d from an alloy, such as carbon steel, or a metal material. Each spring 44e may be an elastic body such as a plate spring.

In the example of FIG. 8, projections extend radially inward from the inner surface of the race 44b. The projections are arranged at equal angular intervals. Grooves are formed between the projections. Each groove includes a sloped surface and a sunken surface. When the rollers 44c are clamped between the inner surface of the race 44b and the shaft 45a, the rollers 44c do not roll and function as locks. As a result, the race 44b and the shaft 45a rotate integrally with each other. When the rollers 44c are not clamped between the inner surface of the race 44b and the shaft 45a, the rollers 44c roll and do not function as locks. As a result, the rotation of the race 44b is not transmitted to the shaft 45a.

For example, when the housing 44a and race 44b of the one-way clutch 44 rotate in the direction indicated by arrow R1 in FIG. 8, the housing 44a, race 44b and rollers 44c transmit torque from the rotary shaft 43 to the brush shaft 45a. In contrast, when the housing 44a and race 44b rotate in the direction indicated by arrow R2 in FIG. 8, the transmission of torque from the rotary shaft 43 to the brush 45 is cut.

Referring to FIGS. 6 and 7, the brush 45 includes the shaft 45a, which is formed from a metal or resin material, and fibers, or bristles 45b, which extend radially outward from the shaft 45a. The case 41 supports the front and rear ends of the shaft 45a so that the brush 45 is rotatable. The bristles 45b have uniform distal ends so that the brush 45 has a cylindrical contour. The distal ends of some of the bristles 45b extend out of the case 41 in an inward direction of the outer case 10. Accordingly, when the cleaning unit 4 moves facing toward the air filter 34, the brush 45 contacts the outer surface of the air filter 34 so that the bristles 45b of the brush 45 remove dust from the air filter 34. This cleans the air filter 34. The dust on the rotating brush 45 is transferred into the dust box 5.

As shown in FIG. 6, the cover 46 covers the motor 42, printed wiring board 42B, and bevel gears 42b and 43a. The case 41 and the cover 46 hold the front ends of the rotary shaft 43 and the brush shaft 45a in a rotatable manner.

The cover 47 covers the spur gear 43b and the one-way clutch 44. By fastening the cover 47 to the case 41, the case 41 and the cover 47 hold the rear ends of the rotary shaft 43 and the brush shaft 45a in a rotatable manner. In this manner, the case 41 and the covers 46 and 47 function as bearings of the rotary shaft 43 and the brush shaft 45a.

Referring to FIG. 9, the dust box 5 has a longitudinal axis and is removable from the case 41. The dust box 5 is separable into an inner case 5A and an outer case 5B. In the illustrated example, the cases 5A and 5B are formed from a resin material. The cases 5A and 5B are pivotally coupled to each other to allow for the dust box 5 to open.

The inner case 5A includes an inner wall 51, a right wall 52, a front wall 53, and a rear wall 54. The inner case 5A includes rods 55, which pivotally couple the cases 5A and 5B.

The inner wall 51 has an outer surface that defines a downstream surface of the dust box 5. Partitions 51a extend from the inner wall 51 to partition the interior of the dust box 5. The partitions 51a prevent dust from being concentrated at the same location in the dust box 5.

The dust remover 6 is arranged on the inner wall 51 to remove dust from the bristles 45b of the brush 45. Clips 51b and projections 51c are formed integrally with the inner wall 51 to couple the dust remover 6 to the inner wall 51. The projections 51c are inserted into holes 61 of the dust remover 6. The clips 51b restrict movement of the dust remover 6.

The right wall 52 extends outward from the right end of the inner wall 51. The front wall 53 extends outward from the front end of the inner wall 51. The rear wall 54 extends outward from the rear end of the inner wall 51.

The rods 55 are arranged in the front and rear ends of the right wall 52. The rods 55 are, for example, cylindrical.

A tongue 57b is arranged on the inner surface of the outer wall 56. When the dust box 5 is closed, the tongue 57b engages with an extension 51d, which is arranged on the distal end of one of the partitions 51a in the inner case 5A. Engagement of the tongue 57b with the extension 51d restricts pivoting of the outer case 5B relative to the inner case 5A and keeps the dust box 5 closed.

A brush cover 57 extends leftward from the outer wall 56. When the dust box 5 is coupled to the case 41, the brush cover 57 covers the rotary shaft 43 and the brush 45, which are arranged in the case 41. In the illustrated example, the brush cover 57 of the dust box 5 is fastened by screws to the case 41 to couple the dust box 5 to the case 41.

The outer case 5B includes rod supports 58, which support the rods 55 of the inner case 5A. This pivotally couples the cases 5a and 5B to each other.

A joint 59 is arranged on each of the front and rear ends of the outer case 5B. Each joint 59 includes an elliptical projection and a cylindrical boss projecting outward from the boss. The case 41 supports the joints 59 when the dust box 5 is coupled to the case 41.

The dust box 5 is formed by the inner wall 51, the right wall 52, the front wall 53, and the rear wall 54. Further, the dust box 5 includes an elongated opening at the left side. Accordingly, when the dust box 5 is coupled to the case 41, the dust box 5 is open toward and parallel to the brush 45. The opening of the dust box 5 is formed to facilitate the collection of dust from the bristles 45b of the brush 45.

The dust box 5 is open in a direction that is the same as the direction in which the optical axes L1 and L2 of the lamps 21a, 21b, 21c, and 21d extend. Thus, when the optical axes L1 and L2 are horizontal, the longitudinal axis of the opening in the dust box 5 is horizontal. In this state, subtle dust escapes the dust box 5.

The dust remover 6 is coupled to the dust box 5. For example, the dust remover 6 is arranged on the left end of the inner case 5A. When the dust box 5 is coupled to the case 41, the edge of the dust remover 6 is arranged to card the bristles 45b of the brush 45. The dust remover 6 includes a surface 62, which faces toward the interior of the dust box 5. Rotation of the brush 45 removes dust from the bristles 45b of the brush 45 with the dust remover 6. The edge of the dust remover 6 may be saw-toothed. In such a case, the dust remover 6 effectively removes dust from the brush 45.

As described above, the air filter device 3 includes the air filter 34, the brush 45, the dust box, which collects dust from the brush 45, and the rotary shaft 43, which rotates the brush 45. The air filter device 3 also includes the racks 35 and 36 and pinions 43A and 43B that form a moving mechanism for moving the brush 45 and dust box 5 using the rotation of the rotary shaft 43.

Rotation of the rotary shaft 43 transmits the torque of the rotary shaft 43 to the pinions 43A and 43B, which are engaged with the racks 35 and 36. The brush 45 and the dust box 5 move along the racks 35 and 36.

The one-way clutch 44 connects the brush 45 to the rotary shaft 43. The one-way clutch 44 transmits torque from the rotary shaft 43 in the first direction but does not transmit the torque in the second direction. The rotation of the rotary shaft 43 and brush 45 and the movement of the cleaning unit 4 will now be described.

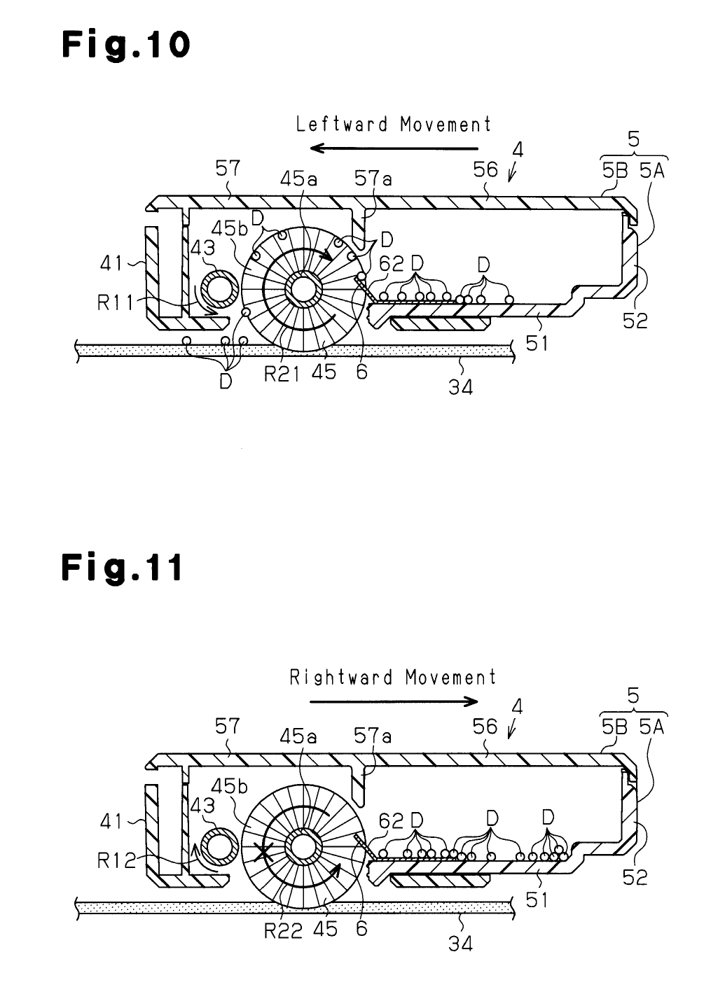

Referring to FIG. 10, when the rotary shaft 43 rotates in the direction of arrow R11, the torque of the rotary shaft 43 is transmitted to the pinions 43A and 43B. In this case, the cleaning unit 4 (i.e., the brush 45 and the dust box 5) moves leftward. Further, rotation of the rotary shaft 43 in the direction of arrow R11 rotates the housing 44a and race 44b in the direction of arrow R1 as shown in FIG. 8. Here, the rollers 44c of the one-way clutch 44 are clamped between the inner surface of the race 44b and the outer surface of the brush shaft 45a. Thus, the rollers 44c do not roll. This integrally rotates the housing 44a, race 44b, and brush shaft 45a. Accordingly, the brush 45 rotates in a direction (i.e., the direction of arrow R21) for transferring dust from the bristles 45b of the brush 45 to the inner surface 62 of the dust remover 6. As a result, the dust removed from the bristles 45b of the brush 45 enters the dust box 5.

As described above, when the cleaning unit 4 moves leftward, the rotating brush 45 cleans the air filter 34. Further, the dust removed from the brush 45 enters and collets in the dust box 5. When the cleaning unit 4 reaches a return position (or remote position) at the left end of the base 31, the cleaning unit 4 moves rightward.

Referring to FIG. 11, when the rotary shaft 43 rotates in the direction of arrow R12 (i.e., the direction opposite to arrow R11), the torque of the rotary shaft 43 is transmitted to the pinions 43A and 43B. In this case, the cleaning unit 4 moves rightward. Further, rotation of the rotary shaft 43 in the direction of arrow R12 rotates the housing 44a and race 44b in the direction of arrow R2 as shown in FIG. 8. Here, the rollers 44c of the one-way clutch 44 move away from the sloped surface of the race 44b against the urging force of the springs 44e and stop functioning as locks. Thus, the rollers 44c of the one-way clutch 44 are not clamped between the inner surface of the race 44b and the outer surface of the brush shaft 45a. As a result, the rollers 44c roll in contact with the race 44b and the brush shaft 45a. In this manner, the one-way clutch 44 cuts the transmission of torque from the rotary shaft 43 to the brush 45.

In the present embodiment, when the cleaning unit 4 moves rightward, that is, when the rotary shaft 43 rotates in the direction of arrow R12, the brush 45 does not rotate in the direction of arrow R22 shown in FIG. 11.

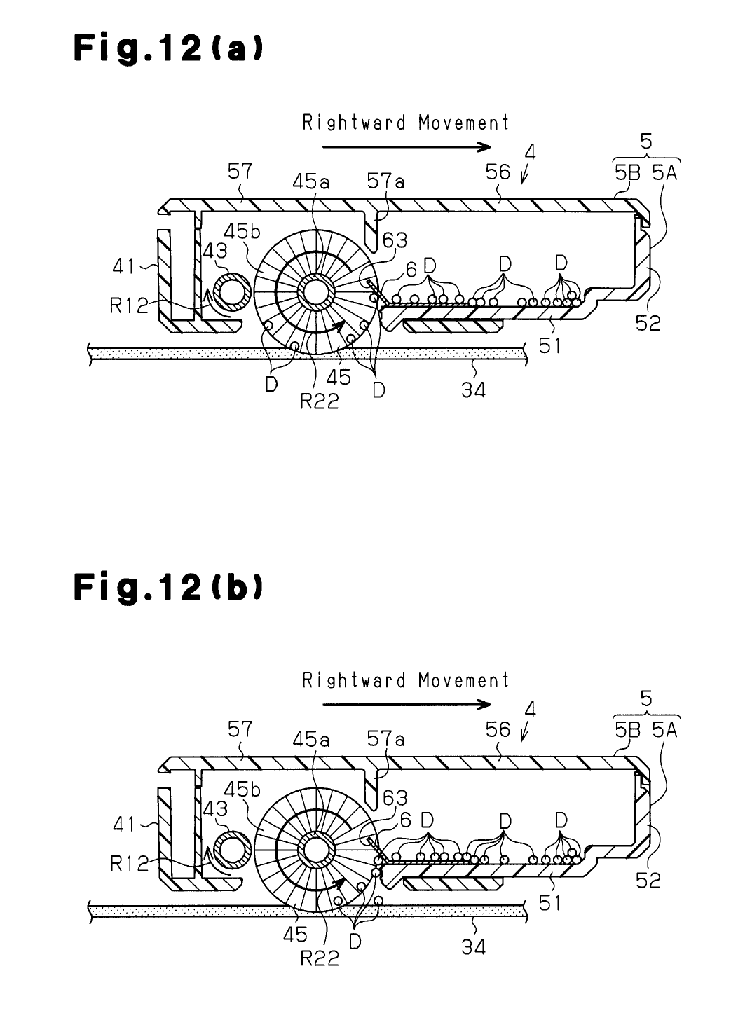

If the brush 45 were to be connected to the rotary shaft 43 without the one-way clutch 44, rightward movement of the cleaning unit 4 would rotate the rotary shaft 43 in the direction of arrow R22 as shown in FIG. 12. In this case, dust removed from the bristles 45b is transferred to an outer surface 63 of the dust remover 6, which is opposite the inner surface 62. Accordingly, when the outer surface 63 removes dust from the brush 45 as shown in FIG. 12(b), the dust may be transferred from the brush 45 to the air filter 34. In this manner, when the brush 45 is rotated in the direction of arrow R22, dust does not collect in the dust box 5.

(1) The air filter device 3 includes the air filter 34, brush 45, dust box 5, rotary shaft 43, and moving mechanism (i.e., the racks 35 and 36 and pinions 43A and 43B). The one-way clutch 44 connects the brush 45 to the rotary shaft 43. The rotary shaft 43, which rotates the brush 45, is used to move the brush 45 and dust box 5 leftward and rightward. Since the one-way clutch 44 connects the brush 45 to the rotary shaft 43, the transmission of torque in a predetermined direction from the rotary shaft 43 to the brush 45 is permitted, and the transmission of torque in the opposite direction from the rotary shaft 43 to the brush 45 is restricted. Accordingly, the one-way clutch 44 cuts the transmission of torque from the rotary shaft 43 to the brush 45 so that the brush 45 does not rotate in the direction of arrow R22 indicated in FIG. 12 even when the rotary shaft 43 rotates in the directions of arrows R11 and R12 and move the brush 45 and dust box 5 back and forth. This prevents the dust on the brush 45 from being transferred to the air filter 34.

(2) The movement mechanism includes the pinions 43A and 43B, which are arranged on the rotary shaft 43. The pinions 43A and 43B are respectively engaged with the racks 35 and 36 to move the brush 45 and the dust box 5 along the racks 35 and 36.

(3) The one-way clutch 44 includes the race 44b and the rollers 44c, which contact the race 44b and the brush shaft 45a. When the rotary shaft 43 rotates in the first direction, the rollers 44c do not roll between the race 44b and the brush shaft 45a and function as locks. When the rotary shaft 43 rotates in the second direction, the rollers 44c roll in contact with the race 44b and the brush shaft 45a. In such a structure, when the rotary shaft 43 rotates in the first direction, the rollers 44c of the one-way clutch 44 transmit torque from the rotary shaft 43 to the brush 45. When the rotary shaft 43 rotates in the second direction, the rollers 44c roll in contact with the race 44b and the brush shaft 45a. This cuts the transmission of torque from the rotary shaft 43 to the brush 45.

(4) The brush 45 and the dust box 5 are coupled to the case 41. Further, the motor 42, which rotates the rotary shaft 43, is coupled to the case 41. This allows for the motor 42 to integrally move the brush 45, the dust box 5, and the case 41.

(5) The dust box 5 is removable from the case 41. This facilitates maintenance, such as cleaning, of the dust box 5.

(6) The dust box 5 includes the dust remover 6, which removes dust from the brush 45. The removal of dust from the brush 45 with the dust remover 6 efficiently collects dust in the dust box 5.

(7) The dust remover 6 includes the surface 62 facing toward the interior of the dust box 5. The one-way clutch 44 transmits the torque of the rotary shaft 43 to the brush 45 as torque that rotates the brush 45 only in the direction in which dust is transferred from the brush 45 to the surface 62. Accordingly, the dust removed from the brush 45 is guided along the surface 62 of the dust remover 6 when entering the dust box 5.

(8) When the dust box 5 is coupled to the case 41, the brush 45 is covered by the brush cover 57 of the dust box 5. This prevents the dust on the brush 45 from being scattered out of the case 41. Further, when the dust box 5 is removed from the dust box 5, the brush 45 is exposed. Thus, removal of the dust box 5 from the case 41 facilitates maintenance of the brush 45.

(9) The projector 1 includes the air filter device 3. Accordingly, the projector has the advantages described above.

It should be apparent to those skilled in the art that the present invention may be embodied in many other specific forms without departing from the spirit or scope of the invention. Particularly, it should be understood that the present invention may be embodied in the following forms.

The moving mechanism is not limited to the racks 35 and 36 and the pinions 43A and 43B. For example, the pinions 43A and 43B may be wheels having a circumferential surface that is does not include teeth.

The one-way clutch 44 is not restricted to the illustrated example. The one-way clutch 44 only needs to connect the brush 45 to the rotary shaft 43 so that the brush 45 does not rotate in the direction of arrow R22.

Torque may be transmitted from the rotary shaft 43 to the brush 45 when moving the brush 45 and the dust box 5 rightward, and the transmission of torque from the rotary shaft 43 to the brush 45 may be cut when moving the brush 45 and the dust box 5 leftward. In other words, the rotation of the brush 45 in the direction of arrow R21 may be restricted when moving the brush 45 and the dust box 5 leftward, and the rotation of the brush 45 in the direction of arrow R21 may be permitted when moving the brush 45 and the dust box 5 rightward. In this manner, the transmission of torque from the rotary shaft 43 to the brush 45 need only be cut when the brush 45 moves in either one of the left and right directions.

The air filter device 3 may be arranged on the left side of the projector 1 instead of the right side. Further, the air filter device 3 may be arranged on the rear side of the projector 1 instead of the front side. The direction in which the brush 45 and the dust box 5 move is not limited to the leftward and rightward directions.

The present invention is not limited to a video projector including four light sources. The present invention may also be applied to a video projector including only one light source or at least two light sources. Further, the video projector is not limited to an LCD projector and may be a video projector that uses a digital micromirror device (DMD) to display an image.

The present examples and embodiments are to be considered as illustrative and not restrictive, and the invention is not to be limited to the details given herein, but may be modified within the scope and equivalence of the appended claims.

1. An air filter cleaner comprising:
an air filter that captures dust;
a brush that cleans the air filter;
a dust box that collects dust from the brush;
a rotary shaft that rotates the brush;
a moving mechanism that moves the brush and the dust box using the rotation of the rotary shaft; and
a one-way clutch that connects the brush and the rotary shaft.

2. The air filter cleaner according to claim 1, wherein the moving mechanism includes a gear arranged on the rotary shaft.

3. The air filter cleaner according to claim 1, wherein
the one way clutch includes
a mechanical element coupled to the rotary shaft, and
a roller arranged between and in contact with the mechanical element and the brush;
when the rotary shaft rotates in a first direction, the roller is clamped between the mechanical element and the brush, stops rolling, and functions as a lock; and
when the rotary shaft rotates in a second direction that is opposite to the first direction, the mechanical element rolls in contact with the mechanical element and the brush.

4. The air filter cleaner according to claim 1, further comprising:
a case to which the brush and the dust box are coupled; and
a motor coupled to the case to rotate the rotary shaft.

5. The air filter cleaner according to claim 4, wherein the dust box is removable from the case.

6. The air filter cleaner according to claim 5, further comprising a dust remover that removes dust from the brush, wherein the dust remover is arranged in the dust box.

7. The air filter cleaner according to claim 6, wherein the dust remover includes a surface facing toward an interior of the dust box; and
the one-way clutch transmits torque from the rotary shaft to the brush as torque that rotates the brush only in a direction that transfers dust from the brush to the surface of the dust remover.

8. The air filter cleaner according to claim 5, wherein:
when the dust box is coupled to the case, the brush is covered by part of the dust box; and
when the dust box is removed from the case, the brush is entirely exposed.

9. The air filter cleaner according to claim 1, wherein
the rotary shaft rotates in a first direction and a second direction;
the brush is rotatable and includes a brush shaft that is parallel to the rotary shaft;
the one-way clutch includes a roller that transmits rotation of the rotary shaft in the first direction to the brush shaft but does not transmit rotation of the rotary shaft in the second direction to the brush shaft.

10. The air filter cleaner according to claim 9, wherein
the brush shaft includes an outer surface;
the mechanical element of the one-way clutch is a ring-shaped mechanical element that is arranged coaxially with the brush shaft and includes an inner surface facing toward the outer surface of the brush shaft;
the inner surface of the ring-shaped mechanical element includes a plurality of projections, which project radially inward, and a plurality of grooves, which are defined between the grooves, wherein each groove includes a sloped surface and a sunken surface;
the roller is one of a plurality of rollers respectively arranged in the grooves of the inner surface of the ring-shaped mechanical element;
when the rotary shaft rotates in the first direction, the rollers are clamped between the outer surface of the brush shaft and the sloped surfaces of the corresponding grooves and stop rolling thereby prohibiting rotation of the brush shaft relative to the ring-shaped mechanical element; and
when the rotary shaft rotates in the second direction, the rollers roll between the outer surface of the shaft and the inner surface of the ring-shaped mechanical element thereby permitting rotation of the brush shaft relative to the ring-shaped mechanical element.

11. A video projector comprising the air filter cleaner according to claim 1.
